(19) United States
(12) Patent Application Publication
(10) Pub. No.: US 2007/0210084 A1
(43) Pub. Date: Sep. 13, 2007

(54) Re-closing Method for Containers

(76) Inventors: Ze'ev Blajwis, Tel Aviv (IL); Naftali Lieber, Zirchron Yaacov (IL); Haim Weiss, Moshav Nirit (IL); Sagi Slutzki, Zirchron Yaacov (IL)

Correspondence Address: BRUCE E. LILLING;LILLING & LILLING PLLC, P.O. BOX 560, GOLDEN BRIDGE, NY, 10526, US

(21) Appl. No.: 11/276,757

(22) Filed: Mar. 13, 2006

(51) Int. Cl. B65B 7/28; B29C 43/02; B65D 51/00

(52) U.S. Cl. 220/200; 264/132; 264/320; 264/138; 264/553; 264/571

(57) ABSTRACT

A method for manufacturing substantially moisture resistant closures for flexible packages, the method comprising providing a roll of material, printing a design on the roll, heating the roll, forming a three-dimensional shape in the roll substantially proximate to the design and cutting the roll substantially proximate to the three-dimensional shape and the design.

### BACKGROUND OF THE INVENTION

1. Field of the Invention

The present invention relates to moisture resistant flexible packaging closures that are printed, molded and die cut from a roll of material.

2. Description of the related art

Flexible packaging is an ubiquitous part of our society, storing contents ranging from moist dog food to dry laundry powder. An efficient flexible package resists moisture, thereby preventing dog food from undue drying out due to excessive moisture egress and laundry detergent from caking due to excessive ingress of moisture.

The requirements on flexible packaging go far beyond providing substantial moisture resistance to laundry detergent and dog food that are typically stored in a home, temperature-controlled environment.

Moist towelettes in flexible packaging, for example, are often stored in an automobile glove compartment, anticipating cleaning soiled hands following a visit to a fast food drive-through or an oil check. The moist towelette packaging must be designed to maintain substantial moisture resistance in spite of sweltering summer days, heat build-up in the glove compartment or freezing winter nights.

An important aspect of maintaining substantial moisture resistance is the package closure, typically comprising two or more hinged plastic pieces that press together to substantially seal the package. Throughout content shelf life and frequent opening and closing, the closure must effectively and repeatedly resist wear out and resultant failure to maintain substantial moisture resistance.

The demands on a flexible package closures, though, extend beyond robustness against wear out. Crucial product information that is printed on closures, for example, warning against consumption of poisonous contents or treatment of eyes exposed to hazardous contents, must be aesthetically appealing, readily applicable and legible throughout the package life.

Additionally, closures must be readily shape-modifiable to reflect new safety feature requirements, new consumer tastes, or new advertising promotions.

Another crucial issue relates to the bulk of the closure that is discarded with the package following use. With greater closure bulk there is more refuse discarded, resulting in greater negative impact on the environment.

Today, the majority of flexible packages closures are manufactured with injection-molded processes. Modifying the shape of an injection-molded closure requires tedious design of a new mold and scrapping an obsolete, yet expensive, injection mold.

Injection molded closures are manufactured without adhesive and adhesives are typically stored and applied to the closures at a distant assembly site, requiring additional costly adhesive application machinery and processes.

Additionally, adhesives applied during assembly of injection molded closures typically require environmentally hazardous solvents and their special permits and waste disposal procedures that add to production costs.

The very assembly process additionally presents problems requiring costly quality assurance procedures. Products such as moist towelettes and food products must be protected during closure assembly from contamination by applied adhesives, particularly adhesives that are solvent-based.

Additionally, injection molded closures utilize plastics that, to maintain strength, require significant bulk, with discarded packages causing significant environmental impact.

With regard to aesthetics, injection molded closures do not provide an even printing surface that is conducive to conventional printing processes. To apply a product warning, for example against consumption, at the most visible location near the opening, requires expensive processes; for example, tampon-printing or screen-printing. As a result, product warnings or instruction are therefore almost never printed on the closures, being relegated to much less visible portions of the package.

Moreover, if lettering is printed directly on the injection-molded closure, the lettering tends to easily rub out, and becomes illegible, due to finger contact.

To allow printing of product warning and information in the most desirable location, over the closure:

U.S. Pat. Nos. 6,152,322 and 6,065,626 and European Patent Application 1,293,156 teach printing processes requiring additional and expensive manufacturing steps;

U.S. Pat. No. 5,647,506 and British Patent 1469313, teach a flexible tape in addition to the injection-molded closure that, again, adds manufacturing steps dedicated to printing, applying adhesive and adhering the tape to the closures.

There appears to be no solution to the costly and tedious process of modifying the shapes of injection-molded closures, the environmental problems associated with closure bulk, and application of hazardous adhesives at distant assembly sites.

In spite of the tremendous need and advantage for a closure that maintains a substantial seal through a process that is readily modifiable at low-cost; and that is environmental friendly, there is currently no apparatus or procedure that provides a flexible packaging closure devoid of the above limitations.

As used herein, a closure refers to a sealable opening and closing device that is attached to flexible packaging, including inter alia towelettes, dog food and laundry detergent; the varied package content and design requirements being well known to those familiar with the art.

As used herein “substantial moisture resistance” means adequately preventing package content moisture loss or gain such that during a projected shelf life of a package, substantial quality of the contents is maintained. As used herein “substantially seal” refers to maintain substantial moisture resistance.

### BRIEF SUMMARY OF THE INVENTION

According to one aspect of the present invention, there is provided a method for manufacturing flexible packaging closures, comprising providing a roll of material, printing a design on the roll, heating the roll, forming a three dimensional shape in the roll substantially proximate to the design, and cutting the shape.

In an exemplary embodiment printing is applied directly to the roll, prior to stamping and cutting the closure. Additionally or alternatively, printing comprises conventional rotary printing, including “flexo” and offset techniques.

In an exemplary embodiment, the three dimensional shape is provided by a stamp. Alternatively, the three dimensional shape is vacuum formed. Optionally, a die provides the cutting.

In an exemplary embodiment, the roll is heated prior to providing the vacuum forming. In a further exemplary embodiment, the method includes forming a lid and a base. Further, an integrated hinge connects the lid and the base. Optionally, the integrated hinge moveably connects the lid and the base.

In a further exemplary embodiment, the base includes an opening and the lid substantially seals the opening when in a closed position.

In an additional embodiment, the lid and the base include locking edges that provide a substantial seal in the closed position. Optionally, the locking edges comprise edges adapted to operatively integrate. Additionally, the locking edges comprise a raised edge on the underside of lid which presses into a depressed edge on the base.

In an exemplary embodiment, the lid includes a lifting tab. In a further exemplary embodiment, the printing includes a marketing message. Optionally, the printing includes product identification. In an additional embodiment, the product identification includes a bar code. Optionally, the product identification includes an embossment.

In an exemplary embodiment, the printing includes a graphic design. Optionally, the graphic comprises at least two colors.

In an exemplary embodiment, the roll includes a pressure sensitive adhesive and the method includes applying the pressure sensitive adhesive to the closure.

In an exemplary embodiment, the roll includes a heat-activated adhesive and the method includes applying the heat-activated adhesive to the closure.

In an exemplary embodiment, the method includes unwinding and rewinding the roll.

Optionally, the method includes separating the shape from the roll. Additionally, the method further includes stacking the separated shapes and, optionally, placing at least one silicone liner between at least two shapes.

In an exemplary embodiment, the method includes changing the three dimensional pattern. Alternatively, the method includes changing the design. Optionally, the method includes changing the pattern of the cut.

In an exemplary embodiment, the method includes using forced air to form the three dimensional pattern. Optionally, the method includes applying a reusable adherent material to the shape.

In an exemplary embodiment, the method includes pressing the shape on a package. Optionally the pressing uses a roller.

There is thus provided a flexible packaging closure that provides substantial moisture resistance, the apparatus comprising a base having an opening there through, a lid adapted to cover the opening, a raised edge on at least one of the base and the lid, a reciprocal depressed edge on at least one of the base and the lid, the reciprocal edge adapted to substantially seal the opening when the depressed edge and the raised edge are pressed together.

Thus, the present invention successfully addresses the shortcomings of the presently known package sealants, providing a low-cost, long lasting package closure that substantially seals package contents, as will be explained below.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

FIG. 1 is a perspective view of a plurality of flexible package closures formed on a roll of material, according to an exemplary embodiment of the present invention;

FIG. 2 is a perspective view of the lower side of the flexible package closure shown in FIG. 1, according to an exemplary embodiment of the present invention;

FIG. 3 is a perspective view of an upper side of the package closure of FIG. 2, according to an exemplary embodiment of the present invention;

FIG. 4 is a perspective view of the package closure of FIG. 3 installed on a package and in the closed position, according to an exemplary embodiment of the present invention; and

FIG. 5 is a perspective view of the package closure of FIG. 3 installed on a package and in the open position, according to an exemplary embodiment of the present invention.

### DETAILED DESCRIPTION OF THE INVENTION

The invention of flexible packaging closures and manufacturing process package is herein described, by way of example only, with reference to the accompanying drawings. With specific reference now to the drawings in detail, it is stressed that the particulars shown are by way of example and for purposes of illustrative discussion of exemplary embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In broad terms, the present invention relates to moisture resistant package closures, manufactured from rolls of material, which are secured to flexible packages. The principles and operation of the package closure design and manufacturing process, according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. In addition, it is to be understood that the phraseology and terminology employed herein is for the purpose of description and should not be regarded as limiting.

This invention pertains to package closures, as well as the method of producing and applying the same for use with disposable packages, for example packages containing, inter alia, dog food, laundry detergent and multiple moist towels.

Closure Design and Manufacture

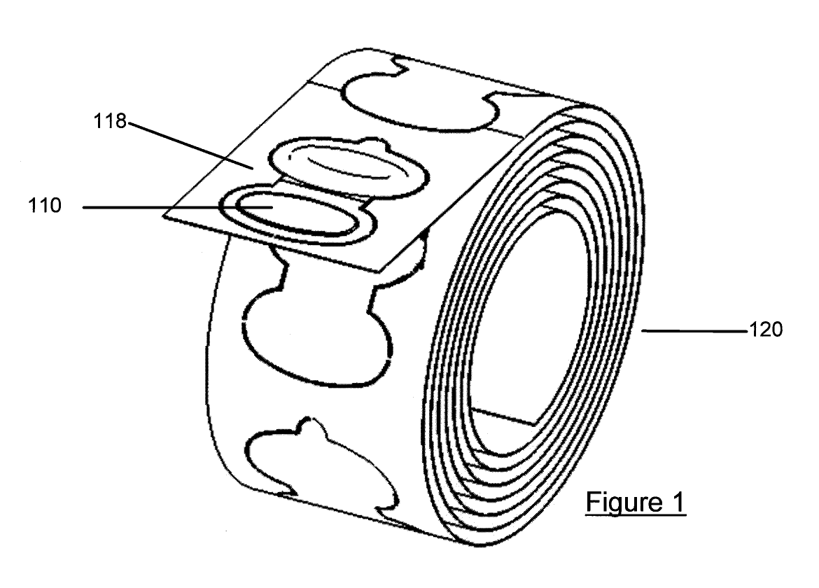

FIG. 1 shows a plurality of package closures 110, printed, stamped and die cut in a roll 120. Roll 120 comprises a sheet of material produced in a number of processes, including core extrusion and lamination. Further, roll 120 may include one or more materials from the group comprising:

poly propylene (PP);

oriented polypropylene (OPP);

bi-oriented polypropylene (BOPP);

polypropylene and poly ethylene (PPPE);

polyvinyl chloride (PVC);

polyvinyl Chloride and polyethylene (PVCPE);

polyester (PET);

polyester and polyethylene (PETPE);

polystyrene (PS);

polycarbonate (PC);

high density poly ethylene (HDPE);

low density poly ethylene (LDPE);

acryl butadiene styrene (ABS);

biostable polymer;

polyurethane;

nylon;

silicone; and

PE laminated carton board.

In an exemplary embodiment printing is applied directly to roll 120, prior to stamping and cutting closure 110. Additionally or alternatively, roll 120 is typically imprinted using conventional rotary printing, for example, “flexo” or offset techniques.

As closures 110 have an even surface, lettering and/or graphics are applied directly to the closure in a cost-effective manner, providing a more aesthetically appealing closure than, for example, adhesive labels applied to the closure.

After a design and/or information have been printed on surface 118, roll 120 is stamped with a raised and/or recessed shape, often using the same machine that providing the printing.

In a typical stamping operation, roll 120 is heated and vacuum shaped over a three-dimensional mold, thereby forming a three-dimensional shape in roll 120 with the above-noted graphics on print surface 118.

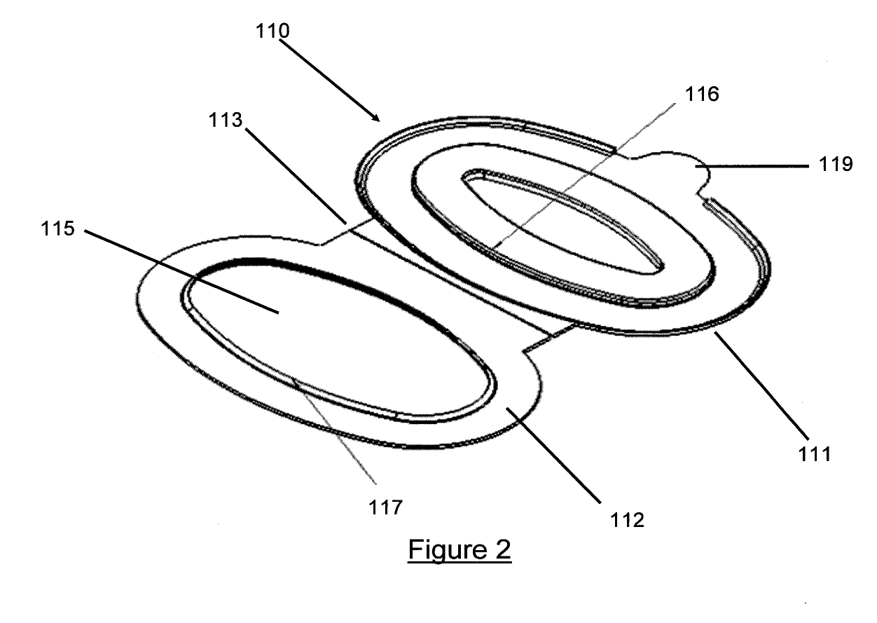

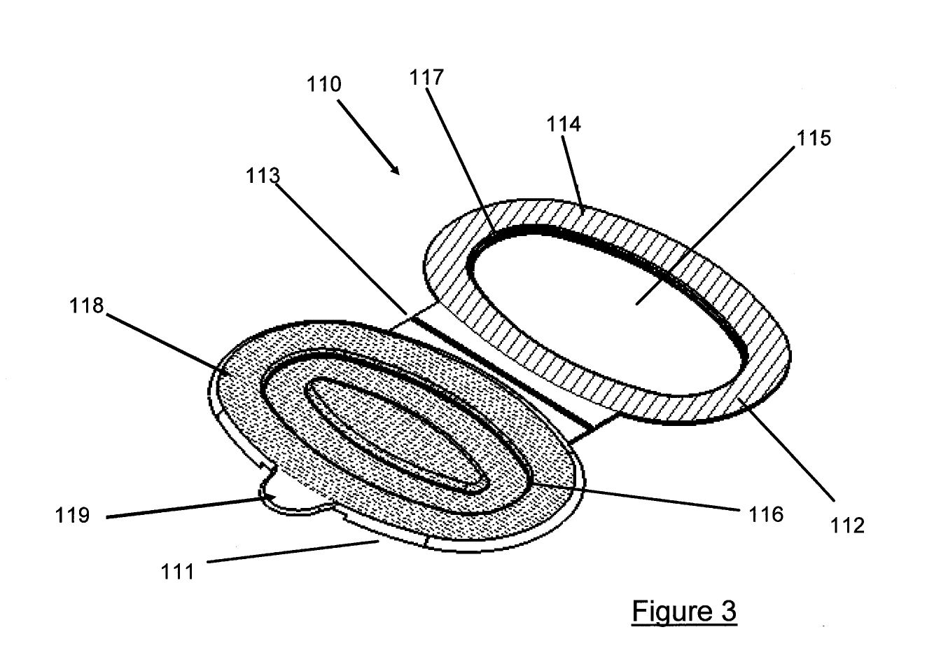

Following stamping, a cutting die is applied to roll 120 to cut excess material 118 from closure device 110, thereby leaving closure fully formed as seen in FIGS. 2 and 3.

Details of closure device 110 following printing, stamping and cutting, are seen in FIGS. 2 and 3. Closure device 110 comprises a lid 111, and a base 112, moveably connected by an integrated hinge 113.

Integrated hinge 113 shapes and/or length are easily changed per customer preference, marketing needs, or package content. For example, hinge 113 is lengthened, along with increasing the size of an opening 115 to provide increased spillage volume required in dispensing professional grade cleaning agents.

In FIG. 2, the underside of lid 111 and upper side of base 112 are shown, while in FIG. 3, the upper (printed) side of cover 111 and the lower side of base 112 are shown.

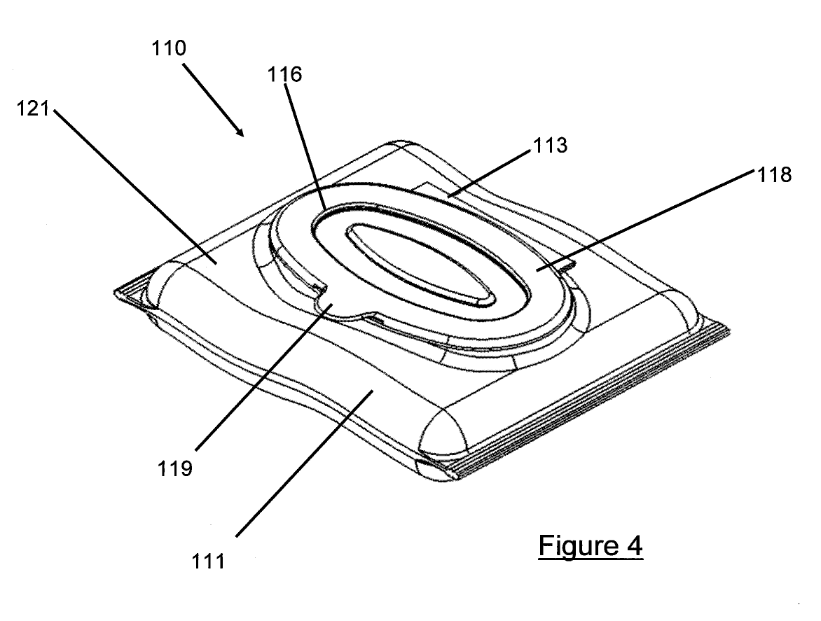

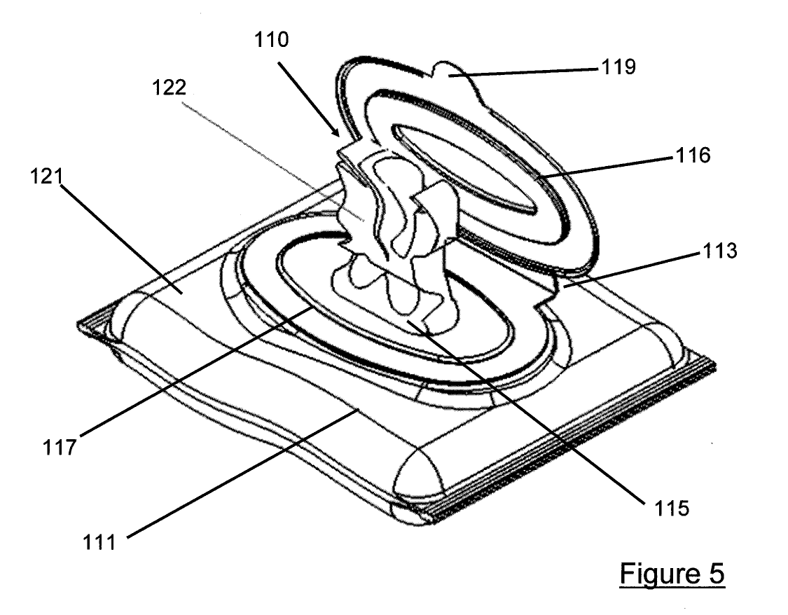

Base 112 includes opening 115 that allows access to the contents of the package to which closure device 110 has been adhered as shown in FIGS. 4 and 5. In exemplary embodiments, lid 111 closes and substantially seals opening 115 of base 112 and is held in the sealed position by locking edges 116 and 117. Locking edges 116 and 117, in an exemplary embodiment seen in FIG. 2, interlock to form a substantially seal when raised edge 116 on the underside of lid 111 is pressed into a depressed edge 117 in the upper side of base 112. Locking edges 116 and 117 are designed to maintain a substantially seal even after repeated opening and closing, thereby providing substantial moisture resistance.

A lifting tab 119 optionally positioned on lid 111 facilitates the easy opening of closure device edges 116 and 117, for example, so that closure device 110 may be opened with a single hand.

FIG. 3 shows details of a printed surface 118 of lid 111. Printed surface 118 is embossed or printed with marketing messages, product identification or any other applicable graphics. As noted above, closure 110 is made with a stamping and printing process, rather than expensive injection-mold dies, allowing rapid and inexpensive changes in three-dimensional shape and die cut.

The materials used in producing the closure base and lid are robust and provide an excellent printing medium, providing a substantial seal that does not break down and lettering that substantially will not rub out, throughout the product shelf life.

Further, text, graphics and closure color are easily altered at relatively low cost as compared to similar changes in injection-molded devices.

Furthermore, relatively low costs in printing, stamping and assembly make high quality and aesthetically appealing closure devices 110 ideal for applying to disposable packages 121.

Closure Adhesives and Packaging

In some exemplary embodiments, an adhesive layer 114 (FIG. 3) comprises a pressure sensitive adhesive (PSA). Packaging and shipping of Pressure Sensitive adhesive closures 110 include application of closure 110 to a silicone liner that is wound into a roll. Additionally, closures 110 are easily and individually dispensed from the silicone liner for assembly. Multiple closure devices 110, for example, are stored on a silicone liner and dispensed in a similar manner to self-adherent address labels.

In alternative embodiments, adhesive layer 114 comprises a dry, non-sticky adhesive, which is heat activated in conjunction with assembly of closures onto packaging. Materials suitable for heat activated adherence include, inter alia, water based adherents; solvent based adherents; and PE adherents.

Water based adherents are typically heat cured and solvent based adherents that are air cured. PE, used for example in home-based heat gun glues, is heated to a temperature that causes PE flow and develop stickiness properties prior to applying to the materials to which closure 110 is being adhered.

In closure applications, heat activated adherents are applied as adhesive layer 114 and remain non-adhesive until activation during assembly. As a result spacers preventing adherence between closures 110 during shipping to a package assembler are typically less bulky than silicone liners used with PSA, thereby reducing liner costs and shipping expenses related to weight and bulk.

Closure Assembly

FIG. 3 shows the lower side of base 112 to which an adhesive layer 114 has been applied. Adhesive layer 114 will be used to attach closure device 110 to a package 121 seen in FIGS. 4 and 5.

In some embodiments, base lower side 112, is prepared for adhesion for example using a corona treatment that is applied to the surface of PE-inclusive materials. Additionally, the type of adhesive used in adhesive layer 114, is determined by many factors, including, inter alia, the type of material to which closure 110 is adhered, contents of package 121, and packing and shipping regulations and procedures; all of which are well known to those familiar with the art.

FIGS. 4 and 5 show an exemplary embodiment of an assembled product, wherein closure device 110 has been assembled on a flexible package 121. FIG. 4 shows closure device 110 in the closed position; FIG. 5 shows closure device 110 in the open position with a moist towel 122 partially removed.

Perforated opening 115 (FIG. 5), that was die cut into base 112 during manufacture of closure 110, serves to restrict movement so that a first towel 122 can be pulled and separated from a second towel inside package 121, even using a single hand. The shape and size of opening 115 will vary, for example, according to the material and size of items that pass through opening 115.

During assembly, closure device 110 is typically placed proximate to a flexible package 121, and secured by being pressed with a roller (FIG. 5). In the presence of heat activated adhesive layer 114, heat is typically used in conjunction with pressing.

Materials and Specifications

The thickness of materials used in the invention are typically thinner than materials used in manufacturing injection-molded prior art, thereby providing significant reduction in bulk that, upon disposal, is more environmental friendly.

In an exemplary embodiment, roll 120 comprises a material that has a thickness of at least about 0.3 millimeters. Alternatively, roll 120 comprises a material that has a thickness of at least about 0.4 millimeters. In other embodiments, roll 120 comprises a material that has a thickness of at least about 0.5 millimeters.

In an exemplary embodiment, roll 120 comprises a material that has a thickness of no more than about 0.8 millimeters. Alternatively, roll 120 comprises a material that has a thickness of no more than about 0.7 millimeters. In other embodiments, roll 120 comprises a material that has a thickness of no more than about 0.6 millimeters.

In exemplary embodiments, the type of material being formed into closure 110 determines material thickness: polypropylene, for example is less than about 0.5 millimeters in thickness while polyethylene is typically more than about 0.6 millimeters in thickness.

In an exemplary embodiment, roll 120 comprises a sheet of material produced in a number of processes, including core extrusion and lamination, noted above.

Further, roll 120 may include one or more materials from the group comprising poly propylene (PP), oriented polypropylene (OPP), bi-oriented polypropylene (BOPP), polypropylene and poly ethylene (PPPE), polyvinyl chloride (PVC), polyvinyl Chloride and polyethylene (PVCPE), polyester (PET), polyester and polyethylene (PETPE), polystyrene (PS), polycarbonate (PC), high density poly ethylene (HDPE), low density poly ethylene (LDPE), acryl butadiene styrene (ABS), biostable polymer, polyurethane, nylon, silicone, and laminated carton boards, including PE laminated carton board.

In a further exemplary embodiment, the biostable polymer comprises a material from the group including a polyolefin, a polyurethane, a fluorinated polyolefin, a chlorinated polyolefin, a polyamide, an acrylate polymer, an acrylamide polymer, a vinyl polymer, a polyacetal, a polycarbonate, a polyether, an aromatic polyester, a polyether (ether ketone), a polysulfone, a silicone rubber, a thermoset, or a polyester (ester imide) and/or combinations thereof.

Additionally, the polymeric polymer comprises a material from the group including a polyolefin, a polyurethane, a silicone, a polyester or a fluorinated polyolefin.

In still further exemplary embodiments, roll 120 comprises a material having a property selected from the group consisting of: compliant, flexible, plastic, and rigid.

Production Process Variations

While closure device 110 is often shaped using the vacuum molding process, noted above, roll 120 may be pressed or formed into desired three-dimensional shapes using forced air alone, or in combination with any one of several other known three dimensional pattern formation methods. The many processes of printing, shaping and cutting closure 110 are well known to those familiar with the art and contemplated for use in conjunction with the instant invention.

Additional variations in production of closure 110, including variations in printing, die stamping, cutting rolls, and assembly of closures; use of multi process and/or single process machinery; and variations related to shipping and assembly, are well known to those familiar with the art and fully contemplated in conjunction with the present invention.

By employing the above-noted materials in any one, or more, of the processes described herein, the final result is a long-lasting, sturdy closure 110 that is economical to manufacture, environmental friendly easy to apply, and/or adapted to readily reflect design specifications of each client with little effort and minimal cost. All these advantages being in addition to ensuring that package 121 is substantially moisture resistant.

It is expected that during the life of this patent many relevant delivery systems will be developed and the scope of the terms flexible package and substantial moisture resistant closures are intended to include all such new technologies a priori.

As used herein the term “about” refers to ±10%.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art.

Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A method for manufacturing substantially moisture resistant closures for flexible packages, the method comprising:
a) providing a roll of material;
b) printing a design on said roll;
c) heating said roll;
d) forming a three-dimensional shape in said roll substantially proximate to said design; and
e) cutting said roll substantially proximate to said three-dimensional shape and said design.

2. The method according to claim 1, wherein said roll comprises at least one material from the group comprising poly propylene, oriented polypropylene, bi-oriented polypropylene, polypropylene and poly ethylene, polyvinyl chloride, polyvinyl Chloride and polyethylene, polyester, polyester and polyethylene, polystyrene, polycarbonate, high density poly ethylene, low density poly ethylene, acryl butadiene styrene, biostable polymer, polyurethane, nylon, silicone, and laminated carton board.

3. The method according to claim 1, wherein said three-dimensional shape is provided by a stamp.

4. The method according to claim 1, wherein a die provides said cutting.

5. The method according to claim 1, wherein said three-dimensional shape is vacuum formed.

6. The method according to claim 5, wherein said roll is heated in conjunction with said vacuum forming.

7. The method according to claim 6, and including forming a lid and a base.

8. The method according to claim 7, wherein said lid and said base are connected by an integrated hinge.

9. The method according to claim 7, wherein said base includes an opening.

10. The method according to claim 9, wherein said lid substantially seals said opening when said lid is pressed against said opening.

11. The method according to claim 10, wherein said lid and said base include locking edges that provide said seal when pressed.

12. The method according to claim 7, including a lifting tab in operative association with said lid.

13. The method according to claim 1, including applying a pressure sensitive adhesive to said roll.

14. The method according to claim 1, including applying a heat activated adhesive to said roll.

15. The method according to claim 1, including separating and stacking said three-dimensional shapes.

16. The method according to claim 1, including changing said three-dimensional shape.

17. The method according to claim 1, including changing said design.

18. The method according to claim 1, including changing a configuration of said cutting.

19. The method according to claim 1, including assembling said closure on a package.

20. A flexible packaging closure that provides substantial moisture resistance, the closure comprising:
a base having an opening there through;
a lid adapted to cover said opening;
a raised edge on at least one of said base and said lid;
a reciprocal depressed edge on at least one of said base and said lid, said reciprocal edge adapted to substantially seal said opening when said depressed edge and said raised edge are pressed together.
